(19) United States
(12) Patent Application Publication
(10) Pub. No.: US 2023/0152063 A1
(43) Pub. Date: May 18, 2023

(54) Incapacitating Chemical Agent Dispersal Using a Portable Electronic Device

(71) Applicant: Crotega, Inc., Crystal, MN (US)

(72) Inventors: Jody Allen Crowe, Crystal, MN (US); Oliver D. Nichols, Crystal, MN (US)

(73) Assignee: Crystal, Inc., Crystal, MN (US)

(21) Appl. No.: 17/556,302

(22) Filed: Dec. 20, 2021

Related U.S. Application Data
(60) Provisional application No. 63/280,571, filed on Nov. 17, 2021.

(51) Int. Cl. F41H 9/10; B05B 11/00

(52) U.S. Cl. CPC F41H 9/10; B05B 11/3057

(57) ABSTRACT

A portable electronic device that selectively deploys a liquid incapacitating chemical agent is described. During operation, the portable electronic device receives or provides a trigger signal. For example, the portable electronic device may include a trigger (such as a mechanical or an electronic trigger), and the portable electronic device may provide the trigger signal when the trigger is activated. Alternatively or additionally, the portable electronic device may provide the trigger signal when an individual is detected in proximity or may receive the trigger signal via wireless communication. In response to the trigger signal, a control circuit provides a control signal to a pump. Then, based at least in part on the control signal, the pump transfers the liquid incapacitating chemical agent from a reservoir to a nozzle. Next, the nozzle discharges the liquid incapacitating chemical agent, e.g., in a stream, where the stream is external to the portable electronic device.

### CROSS REFERENCE TO RELATED APPLICATIONS

This application claims priority under 35 U.S.C. 119(e) to U.S. Provisional Application Ser. No. 63/280,571, entitled “Chemical Spray for Intruder Deterrent and Related Methods,” by Oliver Nichols et al., filed on Nov. 17, 2021, the contents of which are herein incorporated by reference.

### FIELD

The described embodiments relate to techniques for deterring an intruder or potential violence using an incapacitating chemical agent. More specifically, the described embodiments relate to a portable electronic device that selectively deploys an incapacitating chemical agent, such as a water-soluble chemical agent.

### BACKGROUND

Crime, and in particular violence, remains a challenge for civil society. Fundamentally, law enforcement is tasked with enforcing the Law and, thus, in reducing criminal activity. However, the role of the police is typically retroactive. Notably, because of constitutional and resource constraints, police officers are often only able to arrest potential criminals after a crime has occurred. While these efforts can reduce crime over time, there are usually limits in the ability of law enforcement to prevent crimes, especially spontaneous or seemingly random criminal acts. For example, even when police offices are patrolling nearby, crimes can occur. Stated differently, it is simply not possible for police officers to be omnipresent at all times.

Consequently, there is a significant role for citizens, businesses, schools and other organizations in protecting themselves and, thus, in preventing or deterring criminal activity. One type of solution in this regard are handheld devices that deploy chemical agents for self-defense, such as pepper spray, chemical mace or tear gas. In principle, these products offer a proportionate and nonlethal (or less likely to be lethal) response to imminent aggression or violence.

However, in practice, there are problems associated with existing chemical agents for defense. Notably, existing chemical agents are typically not water soluble. Consequently, it is often time-consuming and difficult to reverse the impact of these chemical agents. For example, extensive irrigation is often needed to clean out an existing chemical agent when it gets into an individual's eyes. Moreover, inhalation of the existing chemical agents can cause significant respiratory difficulties or distress, as well as damage to the nose, throat, lungs and corresponding mucous membranes. Furthermore, some existing chemical agents (such as certain types of tear gas) can cause skin irritation, vomiting, chemical burns and/or scarring of the cornea, and symptoms can last for days or may be permanent following exposure. Additionally, the adverse health impacts of existing chemical agents are typically more severe in individuals with chronic health conditions or in small children.

These challenges are compounded by the way the existing chemical agents are deployed. For example, many handheld devices generate an aerosol spray, which is often difficult to target solely at one or more perpetrators. Indeed, the fine particles in an aerosol usually diffuse or drift throughout the surrounding environment and, thus, can adversely impact bystanders or third parties.

### SUMMARY

A portable electronic device that selectively deploys a liquid incapacitating chemical agent, e.g., in a stream is described. This portable electronic device includes: a reservoir with the liquid incapacitating chemical agent, a pump, a nozzle, and a control circuit. During operation, the portable electronic device receives or provides a trigger signal. In response, the control circuit provides a control signal to the pump. Then, based at least in part on the control signal, the pump transfers the liquid incapacitating chemical agent from the reservoir to the nozzle. Next, the nozzle discharges the liquid incapacitating chemical agent in the stream, where the stream is external to the portable electronic device.

For example, the portable electronic device may include a trigger (such as a mechanical or an electronic trigger). When the trigger is activated (such as when an individual pulls a mechanical trigger past an activation threshold or depresses a button), the portable electronic device may provide the trigger signal to the control circuit.

Alternatively or additionally, the portable electronic device may include one or more sensors that perform measurements associated with an external environment of the portable electronic device. For example, the one or more sensors may include: an image sensor, a radar sensor, a lidar sensor, an acoustic sensor, an ultrasonic sensor, or a motion sensor. Moreover, when the portable electronic device is activated (such as when the portable electronic device receives an activation signal or instruction), the portable electronic device may: perform the measurements, analyze the measurements to identify a lifeform in the external environment in proximity to the portable electronic device, and selectively provides the trigger signal to deploy the liquid incapacitating chemical agent based at least in part on the identified lifeform. Furthermore, analyzing the measurements may include performing image analysis on one or more images using a pretrained predictive model, such as a neural network or predictive model trained using a supervised-learning technique. Additionally, identifying the lifeform may include determining a type of lifeform or classification of the lifeform. For example, when the lifeform is an individual, identifying the lifeform may include estimating an emotional state of the individual or an intent of the individual. In some embodiments, the portable electronic device includes an interface circuit that communicates with a second electronic device using wireless communication, and the analysis includes: providing the measurements addressed to the second electronic device; and receiving information that specifies the identified lifeform.

Note that the portable electronic device may include an interface circuit that wireless communicates with a second electronic device, and the portable electronic device may receive the trigger signal from the second electronic device.

In some embodiments, the portable electronic device may include: a handheld electronic device, a backpack, a cart, or a drone (such as an airborne drone or a terrestrial drone or robot).

Moreover, the portable electronic device may include a power source (such as a battery) and/or a connector that can be electrically coupled to an external power source.

Furthermore, the portable electronic device may include a secure memory or a write once read many (WORM) memory. The portable electronic device may selectively increment a value stored in the secure memory or the WORM memory each instance when the liquid incapacitating chemical agent is deployed.

Additionally, the liquid incapacitating chemical agent may be water soluble. Thus, the liquid incapacitating chemical agent may include liquid water as a carrier or a solvent. For example, the liquid incapacitating chemical agent may include: propionic acid, ammonia, and water, where a content of water in the liquid incapacitating chemical agent is at least approximately 60% by weight, and/or a content of propionic acid in the liquid incapacitating chemical agent is at least approximately 17.5% by weight. In some embodiments, the content of propionic acid in the liquid incapacitating chemical agent may be at least approximately 35% by weight. Note that a pH of the liquid incapacitating chemical agent may range from approximately 5.60 to 5.80.

In some embodiments, the liquid incapacitating chemical agent may include a solution of: an organic acid having a pKa of 6 or less, and water, where the solution has a pH between: about 4.5 and about 6.5; about 5 and about 6; or about 5.5 to about 5.9.

Moreover, the organic acid may have a general formula according to Formula I: B-A-COOH (Formula I) where A is selected from the group consisting of a bond, substituted or unsubstituted alkyl, substituted or unsubstituted heteroalkyl, substituted or unsubstituted cycloalkyl, substituted or unsubstituted heterocycloalkyl, substituted or unsubstituted aryl, and/or substituted or unsubstituted heteroaryl; where B is selected from the group consisting of: hydrogen, substituted or unsubstituted alkyl, substituted or unsubstituted heteroalkyl, substituted or unsubstituted cycloalkyl, substituted or unsubstituted heterocycloalkyl, substituted or unsubstituted aryl, substituted or unsubstituted heteroaryl, halogen, hydroxyl, oxo, peroxy acid, amino, azido, nitro, cyano, carboxyl, carbamyl, sulfo, and/or mercapto; and where when A is a bond, B is hydrogen.

Furthermore, when A may be: substituted or unsubstituted alkyl, substituted or unsubstituted heteroalkyl, substituted or unsubstituted cycloalkyl, substituted or unsubstituted heterocycloalkyl, substituted or unsubstituted aryl, or substituted or unsubstituted heteroaryl, the substituted or unsubstituted alkyl, substituted or unsubstituted heteroalkyl, substituted or unsubstituted cycloalkyl, substituted or unsubstituted heterocycloalkyl, substituted or unsubstituted aryl, or substituted or unsubstituted heteroaryl group contains no more than twelve heavy atoms. Additionally, when A may be: substituted or unsubstituted alkyl, substituted or unsubstituted heteroalkyl, substituted or unsubstituted cycloalkyl, substituted or unsubstituted heterocycloalkyl, the substituted or unsubstituted alkyl, substituted or unsubstituted heteroalkyl, substituted or unsubstituted cycloalkyl, substituted or unsubstituted heterocycloalkyl group is unsaturated.

In some embodiments, when B may be: substituted or unsubstituted alkyl, substituted or unsubstituted heteroalkyl, substituted or unsubstituted cycloalkyl, substituted or unsubstituted heterocycloalkyl, substituted or unsubstituted aryl, or substituted or unsubstituted heteroaryl, the substituted or unsubstituted alkyl, substituted or unsubstituted heteroalkyl, substituted or unsubstituted cycloalkyl, substituted or unsubstituted heterocycloalkyl, substituted or unsubstituted aryl, or substituted or unsubstituted heteroaryl group contains no more than twelve heavy atoms. Note that when B may be: substituted or unsubstituted alkyl, substituted or unsubstituted heteroalkyl, substituted or unsubstituted cycloalkyl, substituted or unsubstituted heterocycloalkyl, the substituted or unsubstituted alkyl, substituted or unsubstituted heteroalkyl, substituted or unsubstituted cycloalkyl, substituted or unsubstituted heterocycloalkyl group is unsaturated. Moreover, B may be selected from the group consisting of: hydrogen, halogen, hydroxyl, oxo, peroxy acid, amino, azido, nitro, cyano, carboxyl, carbamyl, sulfo, and/or mercapto.

Furthermore, the organic acid may be a substituted or unsubstituted short chain fatty acid, and/or where the organic acid may not be unsubstituted propionic acid. Additionally, the organic acid may be a substituted or unsubstituted dicarboxylic acid. In some embodiments, the organic acid may be a substituted or unsubstituted tricarboxylic acid. Note that the organic acid may be selected from the group consisting of: acetic acid, acetylenedicarboxylic acid, aconictic acid, adipic acid, aspartic acid, azelaic acid, benzoic acid, butyric acid, isobutyric acid, citraconic acid, citric acid, cyclohexanoic acid, dioxosuccinic acid, diphenic acid, formic acid, fumaric acid, glutaconic acid, glutaric acid, glutamic acid, lactic acid, maleic acid, malic acid, malonic acid, mesaconic acid, mesoxalic acid, muconic acid, niacin, oxalic acid, phthalic acid, pimelic acid, propane 1,2,3-tricarboxylic acid, sebacic acid, sorbic acid, suberic acid, succinic acid, tartaric acid, tartronic acid, terephthalic acid, trimesic acid, valeric acid, isovaleric acid, 2-chlorosuccinic acid, 2-cyanoadipic acid, and/or 2-methylbutyric acid.

Moreover, the solution may include a cosolvent. Furthermore, the cosolvent may be selected from the group consisting of: acetone, methanol, ethanol, n-propanol, isopropanol, glycerol, ethylene glycol, and/or propylene glycol. In some embodiments, the solution may include a base. Additionally, the base may be selected from the group consisting of: ammonia, diethylamine, triethylamine, sodium hydroxide, potassium hydroxide, calcium hydroxide, sodium carbonate, potassium carbonate, calcium carbonate, pyridine, pyrrole, pyrrolidine, and/or imidazole. In some embodiments, the solution may include a surfactant. Note that the surfactant may be selected from the group consisting of: ammonium lauryl sulfate (ALS), sodium lauryl sulfate (SLS), docusate, narrow range ethoxylates (NREs), Triton X-100, Tween 20, Tween 40, Tween 60, and/or Tween 80. Moreover, the surfactant may be alcohol ethoxylates. Furthermore, the solution may include a thickener. Additionally, the thickener may be selected from the group consisting of: alginic acid, an alginate salt, agar, pectin, and/or gelatin. In some embodiments, the solution may include a dye. Note that the solution may include an odorant or flavorant. Moreover, the solution may include a propellant.

Another embodiment provides the liquid incapacitating chemical agent or the composition.

Another embodiment provides an integrated circuit for use with the portable electronic device, which performs at least some of the aforementioned operations.

Another embodiment provides a computer-readable storage medium for use with the portable electronic device. When executed by the portable electronic device, this computer-readable storage medium causes the portable electronic device to perform at least some of the aforementioned operations.

Another embodiment provides a portable device that selectively deploys a liquid incapacitating chemical agent in a stream using mechanical techniques, such as vacuum, compressed gas or hydraulically.

Another embodiment provides a method, which may be performed by the portable electronic device or the portable device. This method includes at least some of the aforementioned operations.

Another embodiment provides a system that includes the portable electronic device or the portable device.

This Summary is provided for purposes of illustrating some exemplary embodiments, so as to provide a basic understanding of some aspects of the subject matter described herein. Accordingly, it will be appreciated that the above-described features are examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

FIG. 1 is a block diagram illustrating an example of a portable electronic device in accordance with an embodiment of the present disclosure.

FIG. 2 is a block diagram illustrating an example of an electronic device and a portable electronic device in accordance with an embodiment of the present disclosure.

FIG. 3 is a flow diagram illustrating an example of a method for selectively deploying a liquid incapacitating chemical agent in a stream using a portable electronic device in accordance with an embodiment of the present disclosure.

FIG. 4 is a drawing illustrating an example of communication among components in a portable electronic device in accordance with an embodiment of the present disclosure.

FIG. 5 is a block diagram illustrating an example of a portable electronic device in accordance with an embodiment of the present disclosure.

FIG. 6 is a block diagram illustrating an example of a portable electronic device in accordance with an embodiment of the present disclosure.

FIG. 7 is a block diagram illustrating an example of a portable electronic device in accordance with an embodiment of the present disclosure.

FIG. 8 is a block diagram illustrating an example of a portable device in accordance with an embodiment of the present disclosure.

FIG. 9 is a flow diagram illustrating an example of a method for selectively deploying a liquid incapacitating chemical agent in a stream using a portable device in accordance with an embodiment of the present disclosure.

FIG. 10 is a block diagram illustrating an example of an electronic device in accordance with an embodiment of the present disclosure.

Note that like reference numerals refer to corresponding parts throughout the drawings. Moreover, multiple instances of the same part are designated by a common prefix separated from an instance number by a dash.

### DETAILED DESCRIPTION

A portable electronic device that selectively deploys a liquid incapacitating chemical agent, e.g., in a stream is described. This portable electronic device includes: a reservoir with the liquid incapacitating chemical agent, a pump, a nozzle, and a control circuit. During operation, the portable electronic device may receive or provide a trigger signal. For example, the portable electronic device may include a trigger (such as a mechanical or an electronic trigger), and the portable electronic device may provide the trigger signal when the trigger is activated. Alternatively or additionally, the portable electronic device may provide the trigger signal when an individual is detected in proximity or may receive the trigger signal via wireless communication. In response to the trigger signal, the control circuit may provide a control signal to the pump. Then, based at least in part on the control signal, the pump may transfer the liquid incapacitating chemical agent from the reservoir to the nozzle. Next, the nozzle may discharge the liquid incapacitating chemical agent in the stream, where the stream is external to the portable electronic device.

By selectively deploying the liquid incapacitating chemical agent, these defense techniques may allow individuals to defend themselves. For example, the liquid incapacitating chemical agent may incapacitate a potential assailant, an intruder, or another individual that has hostile intent or that is committing violent or criminal acts. Moreover, the defense techniques may provide a proportionate and nonlethal response to imminent aggression or violence without the problems associated with existing chemical agents. Notably, the liquid incapacitating chemical agent may be water soluble (such as an aqueous solution of mild acid), and may provide sufficient irritation to human skin and eyes to impede the advance of an assailant, while being easy to reverse, such as by washing it off the skin or irrigating the eyes. This may reduce or eliminate a risk of lasting adverse health impacts following exposure to the liquid incapacitating chemical agent. Furthermore, the liquid incapacitating chemical agent may not pose a risk of respiratory difficulties or distress. Additionally, because the liquid incapacitating chemical agent may be deployed in a stream, it may be easier to target, thereby reducing or eliminating adverse impacts on bystanders or third parties. Consequently, the defense techniques may allow the liquid incapacitating chemical agent to be selectively deployed in a variety of environments, including indoors and/or where crowds or children are present.

Note that the defense techniques may be used by: individuals, businesses, organizations, and/or government agencies (such as law enforcement). Moreover, the defense techniques may be used in a wide variety of environments, such as: the interior of a building (e.g., such as a home, a school, a hospital, an office building, a store or retail establishment, a restaurant, etc.), in a vehicle (such as a car, a bus, a truck, a train, a boat, an aircraft, etc.) and/or an outdoor location (e.g., a park, a concert venue, a patio, a sidewalk, an open garage, a warehouse, etc.)

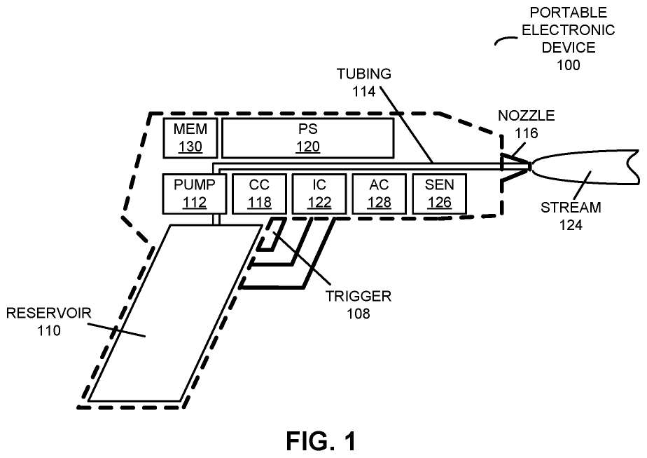

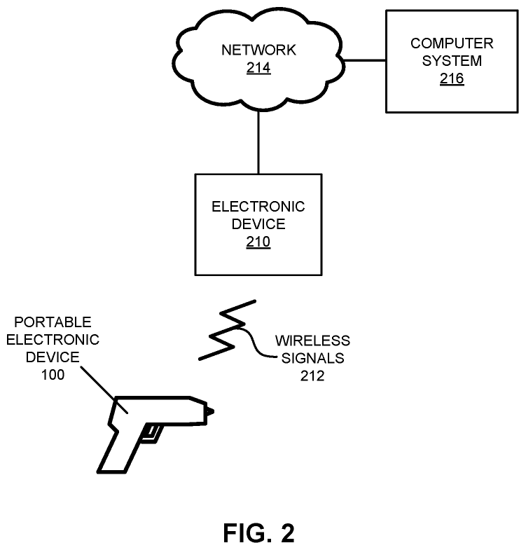

FIG. 1 presents a block diagram illustrating an example of a portable electronic device 100, such as a handheld portable electronic device. This portable electronic device may include: a reservoir 110 filled with a liquid incapacitating chemical agent, a pump 112 (such as an electro-mechanical pump or an electric pump motor) mechanically coupled to reservoir 110, tubing 114 mechanically coupling reservoir 110 and a nozzle 116, and a control circuit (CC) 118 (such as a processor or an integrated circuit). Moreover, portable electronic device 100 may include: an optional trigger 108, such as a mechanical trigger or an electronic trigger. For example, trigger 108 may include a switch or a button. Furthermore, portable electronic device 100 may include a power source (PS) 120 (such as a battery and/or a power regulator circuit) and/or a power connector that can be electrically coupled to an external power source, either or both of which may provide power to electrical components in portable electronic device 100. While not shown in FIG. 1, there may be additional electrical connections between components, such as to power source 120 and/or a power connector. Additionally, as shown in FIG. 2, which presents an example of an electronic device 210 (such as an computer, a cellular telephone, a tablet computer, a smart watch, an access point in a wireless local area network, or a base station in a cellular-telephone network) and portable electronic device 100, portable electronic device 100 may include an optional interface circuit (IC) 122 that communicates with electronic device 210 via wireless communication of wireless signals 212.

Referring back to FIG. 1, when trigger 108 is activated, a trigger signal may be provided to control circuit 118. For example, when a user of portable electronic device 100 pulls back on a mechanical trigger past an activation threshold or depresses a button, the trigger signal may be provided. Alternatively or additionally, in embodiments where portable electronic device 100 includes interface circuit 122, the trigger signal may be received via wireless communication, e.g., from electronic device 210 (FIG. 2). While not shown in FIG. 1, in some embodiments portable electronic device 100 may include an optional safety (not shown) that needs to be removed or moved to an unlocked position before portable electronic device 100 may be used. Moreover, portable electronic device 100 may include an optional trigger guard (not shown) around trigger 108.

In response to the trigger signal, control circuit 118 may provide a control signal to pump 112. Then, based at least in part on the control signal, pump 112 may transfer the liquid incapacitating chemical agent from reservoir 110 to nozzle 116 via tubing 114. Next, nozzle 116 may discharge the liquid incapacitating chemical agent, e.g., in stream 124, where stream 124 is external to portable electronic device 100. For example, stream 124 may be dispensed up to 40 ft from portable electronic device 100.

Note that the liquid incapacitating chemical agent may be discharged as long as trigger 108 is activated (such as while a user has pulled and held trigger 108 past the activation threshold). Alternatively, when trigger 108 activated, there may be a predefined amount of the liquid incapacitating chemical agent that is discharged (e.g., a discharge for 0.5, 1, 3, 5, 10 or 15 s), and then control circuit 118 may cease providing the control signal or may provide a different control signal, either of which may cause pump 212 to cease transferring the liquid incapacitating chemical agent from reservoir 110 to nozzle 116. In some embodiments, when trigger 108 is activated, a series of bursts of the liquid incapacitating chemical agent may be deployed, such as three 1 s bursts separated by 1 s pauses.

While the defense techniques are illustrated with portable electronic device 100 selectively deploying the liquid incapacitating chemical agent in stream 124, in other embodiments a spray of liquid droplets may be used. Note that a ‘stream’ may provide mass transfer of a liquid via a continuous or quasi-continuous flow having an approximately constant cross-sectional area (such as a cross-sectional area that varies by up to 50-100% as a function of time), while a ‘spray’ may provide mass transfer via discrete liquid droplets that are distributed over an area that is larger than the approximately constant cross-sectional area of the stream. More generally, in some embodiments, the incapacitating chemical agent may be: aerosolized (e.g., fine particles that are at least temporarily suspended in the air), dispensed, diffused, etc.

Moreover, while the preceding embodiments illustrated portable electronic device 100 as being locally or remotely triggered (e.g., via trigger 108 or via wireless communication with electronic device 210 in FIG. 2), in other embodiments in the present disclosure portable electronic device 100 may be automatically triggered. For example, portable electronic device 100 may include one or more sensors (SEN) 126 that perform measurements associated with an external environment of portable electronic device 100. In some embodiments, the one or more sensors 126 may include: one or more image sensors (which may be in one or more bands of frequencies, such as the visible spectrum and the infra-red spectrum), a radar sensor, a lidar sensor, an acoustic sensor, an ultrasonic sensor, and/or a motion sensor.

When portable electronic device 100 is activated (such as when portable electronic device 100 receives an activation signal or instruction, e.g., from electronic device 210 in FIG. 2), portable electronic device 100 may: perform the measurements, analyze the measurements (e.g., using an optional analysis circuit or AC 128) to identify a lifeform in the external environment in proximity to portable electronic device 100 (such as an animal or one or more individuals), and selectively provides the trigger signal to deploy the liquid incapacitating chemical agent based at least in part on the identified lifeform.

Note that analyzing the measurements may include performing image analysis on one or more images using a pretrained predictive model, such as a neural network or predictive model trained using a supervised-learning technique and a training dataset. For example, the pretrained predictive model may include a classifier or a regression model that was trained using: a support vector machine technique, a classification and regression tree technique, logistic regression, LASSO, linear regression, a neural network technique (such as a convolutional neural network technique, an autoencoder neural network or another type of neural network technique) and/or another linear or nonlinear supervised-learning technique.

Additionally, identifying the lifeform may include determining a type of lifeform or classification of the lifeform. For example, when the lifeform is one or more individuals, identifying the lifeform may include estimating an emotional state of an individual (such as whether the individual is angry or agitated) or an intent of the individual (such as a possible criminal intent, e.g., based at least in part on a weapon or an object carried by the individual, facial expression, body language or non-verbal communication of the individual, etc.). In some embodiments, the intent is assessed using a pretrained predictive model (such as a neural network) and/or image processing. Moreover, in some embodiments, portable electronic device 100 may, at least in part, determine intent by accessing data about an individual (who may have been identified using a face-recognition technique), such as a remotely located data structure with information about recent social-media posts by the individual. Furthermore, in some embodiments, portable electronic device 100 may adjust the selectively dispensed stream of the liquid incapacitating chemical agent based at least in part on an ability to deter the individual, such as based at least in part on their size, weight and/or speed. For example, in some embodiments, portable electronic device 100 may adjust a pressure and/or a duration of the stream to deter a larger and/or faster moving individual.

In some embodiments, portable electronic device 110 (and, more generally, a portable device) produces a stream or pulse of the liquid chemical agent from a distance between 5-90 feet using a nozzle size between 0.125-0.5 inch and a pressure between 5-100 psi. The stream or pulse may include between 2-45 gallons per minute.

While the preceding example illustrated portable electronic device 100 performing the analysis, in other embodiments of the present disclosure the analysis is performed remotely. For example, as shown in FIG. 2, interface circuit 122 may communicate, via electronic device 210 and network 214 (such as the Internet and/or an intranet), the measurements to remotely located computer system 216 (such as a cloud-based computer system with one or more computers located at one or more geographic locations). After receiving the measurements, computer system 216 may perform the analysis, and then may provide information that specifies the identified lifeform to portable electronic device 100.

Referring back to FIG. 1, in some embodiments, portable electronic device 100 may include a memory (MEM) 130, such as a secure memory or a WORM memory. When portable electronic device 100 selectively deploys the liquid incapacitating chemical agent (e.g., each time the liquid incapacitating chemical agent is deployed), control circuit 118 may selectively increment a value stored in memory 130. This may provide a record of the use of portable electronic device 100 for defense. Note that, while not shown in FIG. 1, portable electronic device 100 may include a viewable display that indicates a ‘shot count’ based at least in part on memory 130, which indicates how many times the liquid incapacitating chemical agent was deployed.

While the preceding embodiments illustrated a fixed nozzle 116, in other embodiments of the present disclosure different nozzles may be remateably coupled to a portable electronic device or a portable device. For example, the different nozzles may have different dispersion patterns (such as a narrow or a broad stream), which may allow coverage area and distance of dispersal to be adjusted. Moreover, in some embodiments, a given nozzle may be coupled to a portable electronic device or a portable device by a flexible tube that can be bent or repositioned in order to direct a stream of the liquid incapacitating chemical agent in different directions, including at a right angle from a direction in which a portable electronic device or a portable device is directed. Furthermore, in some embodiments, reservoir 110 may be remateably coupled to a portable electronic device or a portable device, which may allow an empty current reservoir to be replaced with a full replacement reservoir.

As discussed further below, the liquid incapacitating chemical agent may be water soluble. Thus, the liquid incapacitating chemical agent may include liquid water as a carrier or a solvent. For example, the liquid incapacitating chemical agent may include: propionic acid, ammonia, and water, where a content of water in the liquid incapacitating chemical agent is at least approximately 60% by weight, and/or a content of propionic acid in the liquid incapacitating chemical agent is at least approximately 17.5% by weight. In some embodiments, the content of propionic acid in the liquid incapacitating chemical agent may be at least approximately 35% by weight. Note that a pH of the liquid incapacitating chemical agent may range from approximately 5.60 to 5.80.

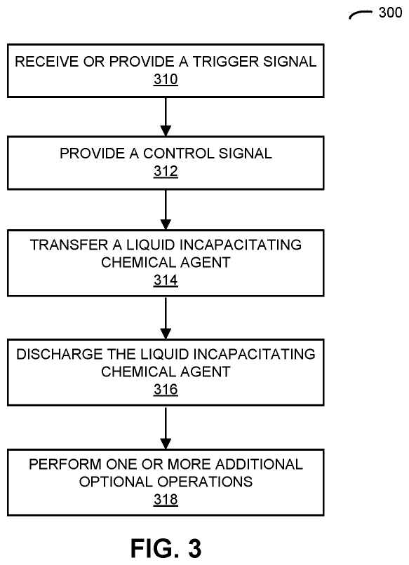

FIG. 3 presents a flow diagram illustrating an example of a method 300 for selectively deploying a liquid incapacitating chemical agent, e.g., in a stream using a portable electronic device, such as portable electronic device 100 in FIG. 1. During operation, the portable electronic device may receive or provide a trigger signal (operation 310). For example, the portable electronic device may include a trigger (such as a mechanical or an electronic trigger). When the trigger is activated (such as when an individual pulls a mechanical trigger past an activation threshold or depresses a button), the portable electronic device may provide the trigger signal. Alternatively or additionally, the portable electronic device may include an interface circuit that wireless communicates with a second electronic device, and the portable electronic device may receive the trigger signal from the second electronic device.

Then, the portable electronic device may provide a control signal (operation 312) to a pump in the portable electronic device based at least in part on the trigger signal. Moreover, the portable electronic device may transfer, using the pump, the liquid incapacitating chemical agent (operation 314) from a reservoir in the portable electronic device to a nozzle in the portable electronic device based at least in part on the control signal. Next, the portable electronic device may discharge, from the nozzle, the liquid incapacitating chemical agent, e.g., in a stream (operation 316), where the stream is external to the portable electronic device.

In some embodiments, the portable electronic device may optionally perform one or more additional operations (operation 318). Notably, the portable electronic device may include one or more sensors that perform measurements associated with an external environment of the portable electronic device. For example, the one or more sensors may include: an image sensor, a radar sensor, a lidar sensor, an acoustic sensor, an ultrasonic sensor, and/or a motion sensor. Moreover, when the portable electronic device is activated (such as when the portable electronic device receives an activation signal or instruction), the portable electronic device may: perform the measurements, analyze the measurements to identify a lifeform in the external environment in proximity to the portable electronic device (such as an animal or an individual), and selectively provides the trigger signal to deploy the liquid incapacitating chemical agent based at least in part on the identified lifeform. Furthermore, analyzing the measurements may include performing image analysis on one or more images using a pretrained predictive model, such as a neural network or predictive model trained using a supervised-learning technique. Additionally, identifying the lifeform may include determining a type of lifeform or classification of the lifeform. For example, when the lifeform is an individual, identifying the lifeform may include estimating an emotional state of the individual or an intent of the individual. In some embodiments, the portable electronic device includes an interface circuit that communicates with a second electronic device using wireless communication, and the analysis includes: providing the measurements addressed to the second electronic device; and receiving information that specifies the identified lifeform.

Note that the portable electronic device may include: a handheld electronic device, a backpack, a cart, or a drone (such as an airborne drone or a terrestrial drone or robot).

Moreover, the portable electronic device may include a power source (such as a battery) and/or a connector that can be electrically coupled to an external power source.

Furthermore, the portable electronic device may include a secure memory or a WORM memory. The portable electronic device may selectively increment a value stored in the secure memory or the WORM memory each instance when the liquid incapacitating chemical agent is deployed.

Additionally, the liquid incapacitating chemical agent may be water soluble. Thus, the liquid incapacitating chemical agent may include liquid water as a carrier or a solvent. For example, the liquid incapacitating chemical agent may include: propionic acid, ammonia, and water, where a content of water in the liquid incapacitating chemical agent is at least approximately 60% by weight, and/or a content of propionic acid in the liquid incapacitating chemical agent is at least approximately 17.5% by weight. In some embodiments, the content of propionic acid in the liquid incapacitating chemical agent may be at least approximately 35% by weight. Note that a pH of the liquid incapacitating chemical agent may range from approximately 5.60 to 5.80.

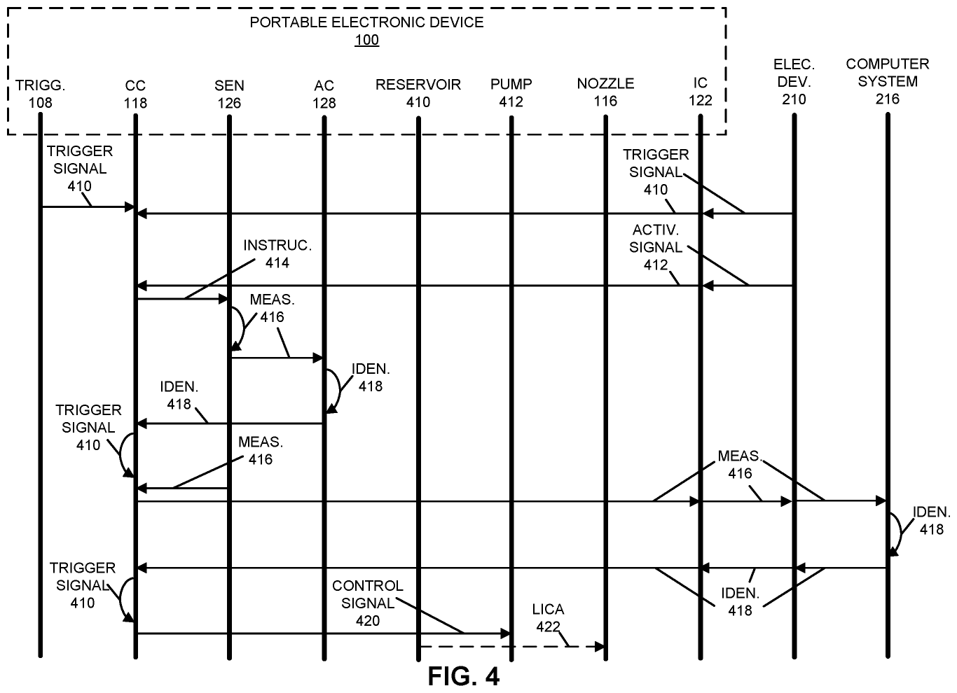

FIG. 4 provides an example of communication among components in portable electronic device 100. When trigger 108 is activated, a trigger signal 410 may be provided to control circuit 118. For example, when a user of portable electronic device 100 pulls back on a mechanical trigger past an activation threshold or depresses a button, trigger signal 410 may be provided. Alternatively or additionally, in embodiments where portable electronic device 100 includes interface circuit 122, trigger signal 410 may be received via wireless communication, e.g., from electronic device 210.

In some embodiments, electronic device 210 provides an activation signal 412 or instruction. After receiving activation signal 412, interface circuit 122 may provide activation signal 412 to control circuit 118. Then, control circuit 118 may instruct 414 the one or more sensors 126 to perform measurements 416, which may provide measurements 416 (or the measurement results) to analysis circuit 128. Analysis circuit 128 may analyze measurements 416 to identify 418 a lifeform, such as an individual. This identification may be provided to control circuit 118, which, in response, provides trigger signal 410.

Alternatively, the one or more sensors 126 may provide measurements 416 to control circuit 118, which instructs interface circuit 122 to provide measurements 416 to computer system 216 via electronic device 210. After receiving measurements 416, computer system 216 may perform the analysis to identify 418 a lifeform, and then may provide information that specifies the identified 418 lifeform to portable electronic device 100. Moreover, after receiving this information, interface circuit 122 may provide the information that specifies the identified lifeform 418 to control circuit 118, which, in response, provides trigger signal 410.

In response to trigger signal 410, control circuit 118 may provide a control signal 420 to pump 112. Then, based at least in part on control signal 420, pump 112 may transfer the liquid incapacitating chemical agent (LICA) 422 from reservoir 110 to nozzle 116. Next, nozzle 116 may discharge liquid incapacitating chemical agent 422, e.g., in stream 124.

While FIG. 4 illustrates communication between components using unidirectional or bidirectional communication with lines having single arrows or double arrows, in general the communication in a given operation in this figure may involve unidirectional or bidirectional communication.

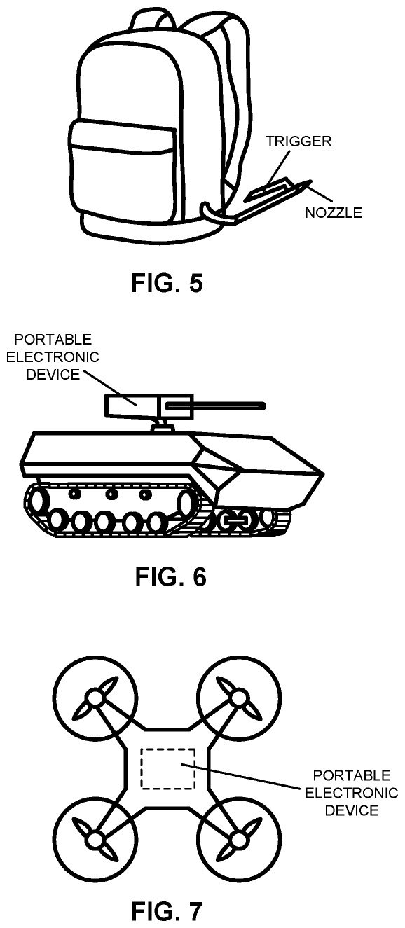

Moreover, while FIG. 1 illustrated a handheld portable electronic device, in other embodiments the portable electronic device may include: a backpack, a cart, or a drone (such as an airborne drone or a terrestrial drone or robot). These are, respectively, illustrated in FIGS. 5-7, which present drawings illustrating examples of portable electronic devices.

Furthermore, while the preceding embodiments illustrated a portable electronic device, in other embodiments some or all of the functions may be implemented with fewer or no electronic components. For example, instead of a pump, vacuum, a hydraulic system, compressed gas or another mechanical system may be used to transfer the liquid incapacitating chemical agent from the reservoir to the nozzle. In some embodiments, a stray bottle or spray can may selectively dispense the liquid incapacitating chemical agent.

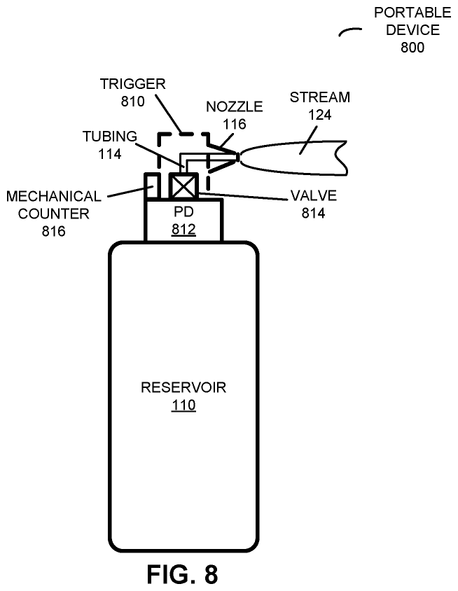

This is shown in FIG. 8, which presents a block diagram illustrating an example of a portable device 800. This portable device 800 may include: a trigger 810 (such as a mechanical trigger, e.g., a spring-loaded trigger, a switch, a button, etc.), a reservoir 110 filled with a liquid incapacitating chemical agent, an optional pressure device (PD) 812 (such as a vacuum system, a hydraulic system or compressed gas canister or propellant) mechanically coupled to reservoir 110, a valve 814, and tubing 114 mechanically coupling reservoir 110 and a nozzle 116.

When trigger 810 is activated (e.g., when a user pushes down on a spring-loaded cap or button. or pulls back on a handle), valve 814 may be mechanically transitioned from a first state to a second state. This may open a path from pressure device 812 to reservoir 110, thereby allowing pressure, vacuum or hydraulic force to transfer the liquid incapacitating chemical agent from reservoir 110 to nozzle 116 via tubing 114. (Thus, in general, the liquid incapacitating chemical agent may be pushed and/or pulled from reservoir 110 to nozzle 116.) Next, nozzle 116 may discharge the liquid incapacitating chemical agent, e.g., in stream 124, where stream 124 is external to portable electronic device 100. While not shown in FIG. 8, in some embodiments portable device 800 may include an optional safety (not shown) that needs to be removed or moved to an unlocked position before portable device 800 may be used. Moreover, portable device 800 may include an optional trigger guard (not shown) around trigger 810.

Note that the liquid incapacitating chemical agent may be discharged as long as trigger 810 is activated (such as while a user has pulled and held trigger 810 past an activation threshold). Alternatively, a user may repeatedly pull back and release trigger 810 in order to mechanically pump the liquid incapacitating chemical agent from reservoir 110 to nozzle 116. In some embodiments, when trigger 810 activated, there may be a predefined amount of the liquid incapacitating chemical agent that is discharged (e.g., a discharge for 0.5-3 s), and then valve 814 may be mechanically transitioned back from the second state to the first state (such as from ‘open’ to ‘closed’).

In some embodiments, portable device 800 includes a mechanical counter 816 that is incremented when trigger 810 is activated (e.g., each time the liquid incapacitating chemical agent is deployed). While not shown in FIG. 1, portable device 800 may include a viewing window that allows mechanical counter 816, so that a ‘shot count’ indicating how many times the liquid incapacitating chemical agent was deployed can be seen.

As discussed further below, the liquid incapacitating chemical agent may be water soluble. Thus, the liquid incapacitating chemical agent may include liquid water as a carrier or a solvent. For example, the liquid incapacitating chemical agent may include: propionic acid, ammonia, and water, where a content of water in the liquid incapacitating chemical agent is at least approximately 60% by weight, and/or a content of propionic acid in the liquid incapacitating chemical agent is at least approximately 17.5% by weight. In some embodiments, the content of propionic acid in the liquid incapacitating chemical agent may be at least approximately 35% by weight. Note that a pH of the liquid incapacitating chemical agent may range from approximately 5.60 to 5.80.

While the preceding embodiments were illustrated with particular components, in other embodiments there may be fewer components, two or more separate components may be combined into a single component, additional components, a single component may be divided into two or more separate components, and/or different components. Moreover, while portable electronic device 100 (FIG. 1) uses electronic and electro-mechanical components, and portable device 800 uses mechanical components, in general combinations of at least some of these components may be used in a portable electronic device.

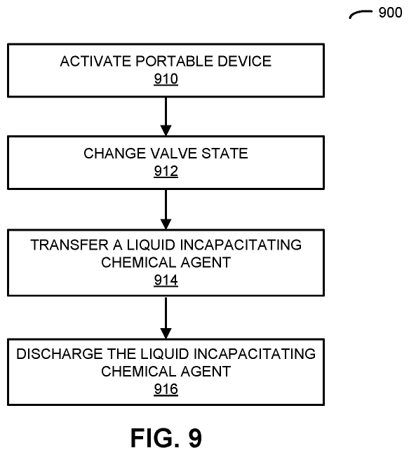

FIG. 9 presents a flow diagram illustrating an example of a method 900 for selectively deploying a liquid incapacitating chemical agent in a stream using a portable device, such as portable device 800 in FIG. 8. During operation, a trigger in the portable device may be activated (operation 910). In response, a valve in the portable device may change state (operation 912). Then, a mechanical force may transfer (operation 914) the liquid incapacitating chemical agent from a reservoir in the portable device to a nozzle in the portable device. Next, the liquid incapacitating chemical agent may be discharged (operation 916) from the nozzle in a stream, where the stream is external to the portable device.

In some embodiments of method 300 (FIG. 3) and/or 900, there may be additional or fewer operations. Furthermore, the order of the operations may be changed, and/or two or more operations may be combined into a single operation.

While the preceding embodiments illustrated the defense techniques with a portable electronic device or a portable device, in other embodiments the liquid incapacitating chemical agent may be selectively deployed using a system integrated into the infrastructure of a predefined location, such as a building. For example, a building may have one or more internal supplies of the liquid incapacitating chemical agent (stored, e.g., within a wall or closet) that are connected via pipes and other plumbing fixtures to one or more nozzles located strategically throughout the predefined location. When the system is activated or a detector detects an intruder, it can trigger the nozzles, or a subsection thereof, to release the liquid incapacitating chemical agent. In some embodiments, the nozzles can dispense the liquid incapacitating chemical agent indefinitely until the supply depletes or a human terminates the action. In other embodiments, the nozzles of the system dispense the liquid incapacitating chemical agent for as long as the individual is detected in the predefined location or the subsection thereof. By the term ‘proximity’ or ‘in the vicinity of the intruder,’ it is to be understood to mean within a space sufficiently close to, but not necessarily narrowly targeted on, the individual such that the liquid incapacitating chemical agent reaches the individual within, e.g., about 30 seconds of the time of release in some embodiments. In other embodiments, the vicinity is close enough such that the liquid incapacitating chemical agent reaches the individual within 15 seconds. In further embodiments, the vicinity is close enough such that the liquid incapacitating chemical agent reaches the individual within 5 seconds.

We now further describe embodiments of compositions of the liquid incapacitating chemical agent. These compositions may be used to deter potential assailants, attackers or intruders. In some embodiments, the composition is a solution includes an organic acid having an aqueous pKa of 6 or less and water, where the solution has a pH of about 4.5 to about 6.5. The solution may include various additives across alternative embodiments, the additives including, but not limited to: cosolvents, bases, surfactants, thickeners, dyes, odorants, flavorants, and/or propellants which serve to, in various selections and combinations, adjust the pH of the solution, improve solubility of the organic acid or other compounds, improve ease of aerosolization of the solution, modulate the wettability of the solution, decrease washability of the solution, improve visual, olfactory, or gustatory recognition of the composition, and/or assist in the delivery of the solution, etc., as described herein. As used herein, the terms ‘composition’ and ‘solution’ are considered equivalent and will be used interchangeably.

A wide variety of organic acids are available throughout many embodiments. By an organic acid, it should be understood to include any chemical including carbon atoms that functions as a Bronsted-Lowry acid. In many examples, such organic acids feature at least one carboxylic acid (—COOH) or sulfonic acid (−S(═O)₂(OH)) group, although other functional groups can sufficiently release an acidic proton in other molecules. As described herein, the organic acid (or mixture of organic acids) of the composition can feature further functional groups than just the at least one carboxylic acid or sulfonic acid group in many embodiments. These additional functional groups can include, but are not limited to: alkyl, heteroalkyl, cycloalkyl, heterocycloalkyl, aryl, heteroaryl, halogen, hydroxyl, oxo, peroxy acid, amino, azido, nitro, cyano, carboxyl, carbamyl, sulfo, mercapto, etc. groups. In certain embodiments, alkyl, heteroalkyl, cycloalkyl, heterocycloalkyl, aryl, and/or heteroaryl groups contain no greater than eight heavy atoms (i.e., non-hydrogen, e.g., C, N, O, S, Si, etc.). A pKa of 6 or less of the organic acid means that the compound should release an acidic proton in the chemical conditions described herein of the composition, bestowing upon the composition the desired physiological irritation.

In other embodiments, the organic acid including a structure according to general Formula I.

B-A-COOH (Formula I)

where A is selected from the group consisting of: a bond, substituted or unsubstituted alkyl, substituted or unsubstituted heteroalkyl, substituted or unsubstituted cycloalkyl, substituted or unsubstituted heterocycloalkyl, substituted or unsubstituted aryl, and substituted or unsubstituted heteroaryl; B is selected from the group consisting of hydrogen, substituted or unsubstituted alkyl, substituted or unsubstituted heteroalkyl, substituted or unsubstituted cycloalkyl, substituted or unsubstituted heterocycloalkyl, substituted or unsubstituted aryl, substituted or unsubstituted heteroaryl, halogen, hydroxyl, oxo, peroxy acid, amino, azido, nitro, cyano, carboxyl, carbamyl, sulfo, and/or mercapto; and where when A is a bond and B is hydrogen. In some embodiments, when A is substituted or unsubstituted alkyl, substituted or unsubstituted heteroalkyl, substituted or unsubstituted cycloalkyl, substituted or unsubstituted heterocycloalkyl, substituted or unsubstituted aryl, and/or substituted or unsubstituted heteroaryl, the substituted or unsubstituted alkyl, substituted or unsubstituted heteroalkyl, substituted or unsubstituted cycloalkyl, substituted or unsubstituted heterocycloalkyl, substituted or unsubstituted aryl, and/or substituted or unsubstituted heteroaryl group contains no more than twelve heavy atoms (i.e., non-hydrogen, e.g., C, N, O, S, Si, etc). In some embodiments, when A is substituted or unsubstituted alkyl, substituted or unsubstituted heteroalkyl, substituted or unsubstituted cycloalkyl, and/or substituted or unsubstituted heterocycloalkyl, the substituted or unsubstituted alkyl, substituted or unsubstituted heteroalkyl, substituted or unsubstituted cycloalkyl, and/or substituted or unsubstituted heterocycloalkyl group is unsaturated.

In some embodiments, when B is substituted or unsubstituted alkyl, substituted or unsubstituted heteroalkyl, substituted or unsubstituted cycloalkyl, substituted or unsubstituted heterocycloalkyl, substituted or unsubstituted aryl, and/or substituted or unsubstituted heteroaryl, the substituted or unsubstituted alkyl, substituted or unsubstituted heteroalkyl, substituted or unsubstituted cycloalkyl, substituted or unsubstituted heterocycloalkyl, substituted or unsubstituted aryl, and/or substituted or unsubstituted heteroaryl group contains no more than twelve heavy atoms (i.e., non-hydrogen, e.g., C, N, O, S, Si, etc). In some embodiments, when B is substituted or unsubstituted alkyl, substituted or unsubstituted heteroalkyl, substituted or unsubstituted cycloalkyl, and/or substituted or unsubstituted heterocycloalkyl, the substituted or unsubstituted alkyl, substituted or unsubstituted heteroalkyl, substituted or unsubstituted cycloalkyl, and/or substituted or unsubstituted heterocycloalkyl group is unsaturated. In other embodiments, B is selected from the group consisting of hydrogen, halogen, hydroxyl, oxo, peroxy acid, amino, azido, nitro, cyano, carboxyl, carbamyl, sulfo, and/or mercapto.

In some embodiments, the organic acid is a short chain fatty acid (SCFA). SCFAs are aliphatic chains of five or fewer carbons featuring a carboxylic acid group (the carbon of the carboxylic acid group is counted towards the total carbon count). As used herein, when an SCFA is said to be ‘unsubstituted,’ it features only its necessary carboxylic acid; when an SCFA is said to be ‘substituted,’ it features at least one additional functional group as described herein and/or at least one C—C linkage that is unsaturated. A comprehensive list of unsubstituted SCFAs include: formic acid, acetic acid, propionic acid, butyric acid, isobutyric acid, valeric acid, isovaleric acid, and/or 2-methylbutyric acid. All of the above unsubstituted SCFAs have an aqueous pKa of less than 6. In some embodiments, when the organic acid is an SCFA, it is not unsubstituted propionic acid.

In some embodiments, the organic acid can be a substituted SCFA. Examples of substituted SCFAs can include, but are not limited to, the various hydroxybutyric acids, 2-hydroxypropioinic acid (a.k.a., lactic acid), nitroacetic acid, etc. One of skill in the art will appreciate how certain compounds not normally associated with SCFAs can be considered ‘substituted SCFAs.’ For example, the dicarboxylic acid adipic acid can be considered as a ‘carboxylic acid-substituted valeric acid’ with the additional carboxyl group attached to the opposing terminal carbon. Similarly, the compound citric acid can be considered as a substituted butyric acid with an additional hydroxyl group at the third carbon and extra carboxyl groups on the third and fourth carbons from the standard ‘head’ carbon (the carbon of the carboxylic acid) of an unsubstituted butyric acid. Other examples can include, but are not limited to: succinic acid (carboxy-substituted propionic acid), malic acid (carboxyl- and hydroxyl-substituted propionic acid), tartaric acid (carboxyl- and dihydroxyl-substituted propionic acid), benzoic acid (phenyl-substituted formic acid), and/or niacin (pyridine-substituted formic acid). In other embodiments, these compounds can be considered as separate categories of substituted or unsubstituted dicarboxylic acids or, more generally, as organic acids. Regardless of their categorization, one of skill in the art will appreciate that the presence of additional functional groups (e.g., carboxylic acids, hydroxyl groups, aryl groups, etc.) in the above examples can produce dramatic differences in the molecules' physical properties (e.g., pKa, solubility, vapor pressure, melting point, etc.) when compared to unsubstituted SCFAs.

In other embodiments, the organic acid is a substituted or unsubstituted dicarboxylic acid. Dicarboxylic acids are organic compounds that contain two carboxylic acid groups. These compounds can be linear or branched, saturated or unsaturated, and some can include an aryl or heteroaryl group in various embodiments. Common saturated and unsubstituted dicarboxylic acids include, but are not limited to: oxalic acid, malonic acid, succinic acid, glutaric acid, adipic acid, pimelic acid, suberic acid, azelaic acid, sebacic acid, etc. Unsaturated dicarboxylic acids include, but are not limited to: maleic acid, fumaric acid, acetylenedicarboxylic acid, glutaconic acid, muconic acid, citraconic acid, mesaconic acid, etc. Aromatic dicarboxylic acids can include, but are not limited to: phthalic acid, terephthalic acid, diphenic acid, etc. Additionally, dicarboxylic acids can be further substituted with one or more various functional groups at any available position. In some embodiments, the one or more substitution groups are selected from the group consisting of: alkyl, heteroalkyl, cycloalkyl, heterocycloalkyl, aryl, heteroaryl, halogen, hydroxyl, oxo, peroxy acid, amino, azido, nitro, cyano, carboxyl, carbamyl, sulfo, and/or mercapto. In further embodiments, the one or more substitution groups are selected from the group consisting of: halogen, hydroxyl, oxo, peroxy acid, amino, azido, nitro, cyano, carboxyl, carbamyl, sulfo, and/or mercapto. Examples of substituted dicarboxylic acids include, but are not limited to: tartronic acid, mesoxalic acid, malic acid, tartaric acid, aspartic acid, dioxosuccinic acid, glutamic acid, 2-chlorosuccinic acid, 2-cyanoadipic acid, etc.

In other embodiments, the organic acid is a substituted or unsubstituted tricarboxylic acid. Tricarboxylic acids are organic compounds that contain three carboxylic acid groups. These compounds can be saturated or unsaturated, include aromatic groups (i.e., aryl or heteroaryl groups), and/or are further substituted by additional functional groups in various embodiments. In some embodiments, tricarboxylic acids can be considered as a substituted dicarboxylic acid having an additional carboxy group. In some embodiments, the one or more substitution groups are selected from the group consisting of: alkyl, heteroalkyl, cycloalkyl, heterocycloalkyl, aryl, heteroaryl, halogen, hydroxyl, oxo, peroxy acid, amino, azido, nitro, cyano, carboxyl, carbamyl, sulfo, and/or mercapto. In further embodiments, the one or more substitution groups are selected from the group consisting of: halogen, hydroxyl, oxo, peroxy acid, amino, azido, nitro, cyano, carboxyl, carbamyl, sulfo, and/or mercapto. Examples of tricarboxylic acids include, but are not limited to: citric acid, aconictic acid, propane 1,2,3-tricarboxylic acid, trimesic acid, etc.

In some embodiments, the organic acid is selected from the group consisting of: acetic acid, acetylenedicarboxylic acid, aconictic acid, adipic acid, aspartic acid, azelaic acid, benzoic acid, butyric acid, isobutyric acid, citraconic acid, citric acid, cyclohexanoic acid, dioxosuccinic acid, diphenic acid, formic acid, fumaric acid, glutaconic acid, glutaric acid, glutamic acid, lactic acid, maleic acid, malic acid, malonic acid, mesaconic acid, mesoxalic acid, muconic acid, niacin, oxalic acid, phthalic acid, pimelic acid, propane 1,2,3-tricarboxylic acid, sebacic acid, sorbic acid, suberic acid, succinic acid, tartaric acid, tartronic acid, terephthalic acid, trimesic acid, valeric acid, isovaleric acid, 2-chlorosuccinic acid, 2-cyanoadipic acid, and/or 2-methylbutyric acid.

Some embodiments can contain two or more organic acids. Using a combination of two or more organic acids in some embodiments can yield desired physical properties, such as improved physiological irritation or solubility of one or more of the components. In various embodiments, the two acids can be present in various weight ratios. Their respective weight ratios can range from about 5:95 to about 95:5 in some embodiments. In other embodiments, their weight ratios can range from about 25:75 to about 75:25. In still further embodiments, their weight ratios can be about 50:50. A solution containing a combination of two or more organic acids can further includes any other additives or materials as described herein.

In many embodiments, the composition includes at least one organic acid in water to form an aqueous solution. In some embodiments, the water can be deionized, distilled, or otherwise purified to a lab-grade quality. In other embodiments, the water can be municipal tap water readily available from standard infrastructure. In certain embodiments, additional miscible cosolvents can be included to assist in the solubility of some compounds (e.g., certain organic acids) or to modify other physical properties (e.g., wettability, viscosity, melting point, freezing point, etc.). Examples of cosolvents miscible with water include, but are not limited to: acetone, methanol, ethanol, n-propanol, isopropanol, glycerol, ethylene glycol, and/or propylene glycol.

In many embodiments, the composition has a pH of about 4.5 to about 6.5. In other embodiments, the composition has a pH of about 5 to about 6. In still further embodiments, the composition has a pH of about 5.5 to about 5.9. The mild acidity of the solution provides the majority of the physiological irritation that deters or incapacitates a potential assailant, an attacker or an intruder when sprayed. When droplets of the composition reach the skin, the acidity can induce a distracting burning or itching sensation. Additionally, in some embodiments aerosolized droplets of the composition (e.g., in a spray) can sufficiently sting the eyes, forcing the intruder to close or wipe them. Furthermore, when inhaled, the acidity of the composition can irritate the lungs, provoking the individual to cough. However, the pH of the composition is carefully selected to be mild such that the adverse effects can be readily reversed by one or all of: washing one's skin and eyes and/or removal to clean air, absent the aerosolized or liquid composition. In this manner, the composition can provide substantial irritation to delay or distract an intruder while any bystanders accidently sprayed can easily cure their condition once safe.

To acquire an aqueous solution of the organic acid at a particular pH, either the acid can be accurately diluted, or an excess of the acid can be sufficiently neutralized by an added base. The excess of organic acid can be considered as a weight percentage beyond what would be needed to generate a solution of the desired pH at a chosen quantity of water by dilution alone. For example, in some embodiments, the acid can be in excess of about 5% to about 200% by weight. This means that, for the chosen quantity of water, there is about 5% to about 200% by weight extra acid over what would produce the desired pH of the solution in that chosen quantity of water. In other embodiments, the organic acid can be in excess of about 5% to about 100% by weight. In still other embodiments, the organic acid can be in excess of about 5% to about 50% by weight. This excess of organic acid can then be neutralized with the addition of a base to generate the desired pH. Examples of bases include, but are not limited to: ammonia, diethylamine, triethylamine, sodium hydroxide, potassium hydroxide, calcium hydroxide, sodium carbonate, potassium carbonate, calcium carbonate, pyridine, pyrrole, pyrrolidine, and/or imidazole. As used herein, the term ammonia can mean both its use as a gas or in its more common form of ammonium hydroxide.

Manufacturing the composition with the process of diluting an organic acid can simplify manufacturing costs and procedures by requiring fewer ingredients, while the use of a base to neutralize an excess of acid may further impart beneficial physical properties to the solution by the addition of the further components. In some embodiments, the presence of a base within the composition can contribute to further physiological irritation.

In some embodiments, the composition further includes a surfactant. A surfactant is a compound the interferes with the surface tension of a liquid (e.g., water), thereby modulating some of the solution's physical properties. In many embodiments, a surfactant can be used to improve solubility of other materials in solution or improve wettability of the solution. Example surfactants include, but are not limited to: anionic surfactants (e.g., common soaps such as ammonium lauryl sulfate (ALS), sodium lauryl sulfate (SLS), and docusate), non-ionic surfactants such as narrow range ethoxylates (NREs) (including alcohol ethoxylates), alkylphenol ethoxylates (e.g., Triton X-100), and/or fatty acid esters of sorbitol (e.g., Tween 20, Tween 40, Tween 60, and Tween 80).

In some embodiments, the composition further includes a thickener. Thickeners can increase the viscosity of the solution or make the solution oilier, thereby making the solution more difficult to readily wash off. While increased viscosity may decrease the ease at which the compound sprays or decrease the distance required for spraying in some embodiments, it can be helpful in other embodiments to reach a desired thickness such that the composition appropriately sticks to an intruder to induce or increase its incapacitating effects. Examples of thickeners or viscosity modification agents can include: alginic acid, alginate salts, polyacrylate, agar, pectin, and/or gelatin.

In some embodiments, the composition further includes a dye. The use of a dye allows for a more expedient visual recognition of the presence of the composition in the air and on persons. This can greatly contribute to the ease of which civilians, or medical personnel assisting civilians, can identify who has been sprayed and on what parts of their bodies. Example dyes include food dyes permitted by regional regulatory agencies (e.g., FD&C Red No. 40, FD&C Yellow No. 5, etc.), fluorescing dies or another dye.

In some embodiments, the composition further includes one or more odorants or flavorants. In these embodiments, the presence of an odorant can either serve to mask an unwanted or foul smell of the composition or contribute a foul smell to the composition to make it further distracting. Furthermore, a strong smell can allow civilians and medical personnel to readily identify areas of a building that have been sprayed as well as which civilians have been sprayed. Similarly, the presence of a flavorant in the composition can either serve to mask an unwanted flavor of the composition or further contribute a foul flavor to enhance its unpalatableness. Examples of odorants and flavorants include, but are not limited to: vanillin, various mint extracts, butanal, ethanethiol, putrescine, skatole, etc.

In some embodiments, the composition further includes a propellant to aid in the composition's dispersal and release from certain delivery vessels (e.g., an aerosol can). In various embodiments, the propellant can be a hydrocarbon (e.g., propane, n-butane, isobutane), nitrogen, oxygen, carbon dioxide, or nitrous oxide, although any other propellants can be used in alternative embodiments (e.g., various ethers or hydrofluoroalkanes).

### PROPHETIC EXAMPLES

### Example 1

In one embodiment of the disclosure, a solution for deterring an individual includes acetic acid diluted in water. Acetic acid is an SCFA having molecular formula CH₃COOH and a pKa of 4.76. Sufficient water can be added to any chosen weight of acetic acid in order to dilute it to generate a solution pH of about 4.5 to about 6.5. In some embodiments, sufficient water is added to generate a solution pH of about 5.7. In certain embodiments, the solution is about 5% to about 90% water by weight. In other embodiments, the solution can include additional materials, including but not limited to: cosolvents, surfactants, thickeners, odorants, flavorants, and/or propellants. The solution can then be used to spray onto an individual as a deterrent or otherwise stored for such future use.

### Example 2

In one embodiment of the disclosure, a solution for deterring an individual includes an excess of butyric acid in water mixed with a quantity of ammonia (or ammonium hydroxide as described herein) to neutralize sufficient acid in order to generate a solution having a pH of about 4.5 to about 6.5. In some embodiments, the solution has a pH of about 5.7. Butyric acid is an SCFA having a pKa of 4.82. As described herein, the butyric acid can be in excess of about 5% to about 200% by weight and subsequently neutralized with ammonia to generate the desired pH. In other embodiments, the solution can include additional materials, including but not limited to: cosolvents, surfactants, thickeners, odorants, flavorants, and/or propellants. The solution can then be used to spray onto an individual as a deterrent or otherwise stored for such future use.

### Example 3

In one embodiment of the disclosure, a solution for deterring an individual includes benzoic acid diluted in water. Benzoic acid is an organic acid having a pKa of 4.20. Sufficient water can be added to any chosen weight of benzoic acid in order to dilute it to generate a solution pH of about 4.5 to about 6.5. In some embodiments, sufficient water is added to generate a solution pH of about 5.7. However, in some embodiments, benzoic acid's limited solubility can impede the formulation of an aqueous solution of benzoic acid. In these embodiments, a cosolvent that is both miscible in water and a better solvent for benzoic acid can be employed. For example, sufficient methanol and/or ethanol can be mixed in to allow enough benzoic acid to dissolve to generate a solution of desired pH. In other embodiments, the solution can include additional materials, including but not limited to: cosolvents, surfactants, thickeners, odorants, flavorants, and/or propellants. The solution can then be used to spray onto an individual as a deterrent or otherwise stored for such future use.

### Example 4

In one embodiment of the disclosure, a solution for deterring an individual includes an excess of lactic acid in water mixed with a quantity of sodium hydroxide to neutralize sufficient acid in order to generate a solution having a pH of about 4.5 to about 6.5. In some embodiments, the solution has a pH of about 5.7. Lactic acid is an organic acid having a pKa of 3.86. In some embodiments, lactic acid can be considered a substituted SCFA. As described herein, the lactic acid can be in excess of about 5% to about 200% by weight and subsequently neutralized with sodium hydroxide to generate the desired pH. Although lactic acid and sodium hydroxide have excellent solubility in water, it can be desired in certain embodiments to add a surfactant to modulate the solutions physical properties. In this embodiment, the solution further includes ethoxylated alcohols. In other embodiments, the solution can include additional materials, including but not limited to: cosolvents, surfactants, thickeners, odorants, flavorants, and/or propellants. The solution can then be used to spray onto an individual as a deterrent or otherwise stored for such future use.

### Example 5

In one embodiment of the disclosure, a solution for deterring an individual includes tartaric acid diluted in deionized water. The naturally occurring enantiomer of tartaric acid, as a diprotic acid, has pKas of 2.89 and 4.40, although in other embodiments, the meso or alternative enantiomer can be used. Sufficient water can be added to any chosen weight of tartaric acid in order to dilute it to generate a solution pH of about 4.5 to about 6.5. In some embodiments, sufficient water is added to generate a solution pH of about 5.7. Because tartaric acid can chelate metal ions in solution, in some embodiments, this property can be avoided by using deionized, distilled or otherwise purified water that lacks or has negligible concentrations of metal ions. Additionally, the solution can include an odorant and/or flavorant to mask or augment the taste and scent of tartaric acid to yield either a more palatable or pungent sensation. In other embodiments, the solution can include additional materials, including but not limited to: cosolvents, surfactants, thickeners, odorants, flavorants, and/or propellants. The solution can then be used to spray onto an individual as a deterrent or otherwise stored for such future use.

### Example 6

In one embodiment of the disclosure, a solution for deterring an individual includes an excess of citric acid in water mixed with a quantity of calcium carbonate to neutralize sufficient acid in order to generate a solution having a pH of about 4.5 to about 6.5. In some embodiments, the solution has a pH of about 5.7. Citric acid, as a triprotic acid, has pKas of 3.13, 4.76, and 6.39. As described herein, the citric acid can be in excess of about 5% to about 200% by weight and subsequently neutralized with calcium carbonate to generate the desired pH. In this embodiment, the dissolved calcium ions then become available for chelation by the citric acid. In certain embodiments, this chelation effect can be desired. In other embodiments, the solution can include additional materials, including but not limited to: cosolvents, surfactants, thickeners, odorants, flavorants, and/or propellants. The solution can then be used to spray onto an individual as a deterrent or otherwise stored for such future use.

### Example 7

In one embodiment of the disclosure, a solution for deterring an individual includes cyclohexanoic acid diluted in water. Cyclohexanoic acid is an organic acid having a pKa of 4.9. Sufficient water can be added to any chosen weight of cyclohexanoic acid in order to dilute it to generate a solution pH of about 4.5 to about 6.5. In some embodiments, sufficient water is added to generate a solution pH of about 5.7. However, due to cyclohexanoic acid's limited solubility in water, the solution can further include a thickener with or without a cosolvent to both improve cyclohexanoic acid's solubility in increase the viscosity of the solution to allow it to better stick to an individual when sprayed. In some embodiments, the thickener can be gelatin. In some embodiments, the additional cosolvent is ethylene glycol or n-propanol. In other embodiments, the solution can include additional materials, including but not limited to: cosolvents, surfactants, thickeners, odorants, flavorants, and/or propellants. The solution can then be used to spray onto an individual as a deterrent or otherwise stored for such future use.

### Example 8

In one embodiment of the disclosure, a solution for deterring an individual includes acetic acid and malic acid diluted in water. Acetic acid is an SCFA having molecular formula CH₃COOH and a pKa of 4.76, and malic acid is a dicarboxylic acid having pKas of 3.40 and 5.20. Sufficient water can be added to any chosen combined weight of the two acids in order to dilute it to generate a solution pH of about 4.5 to about 6.5. In some embodiments, sufficient water is added to generate a solution pH of about 5.7. As described herein, the acetic acid and malic acid can be present in a range of weight ratios. In other embodiments, the solution can include additional materials, including but not limited to: cosolvents, surfactants, thickeners, odorants, flavorants, and/or propellants. The solution can then be used to spray onto an individual as a deterrent or otherwise stored for such future use.

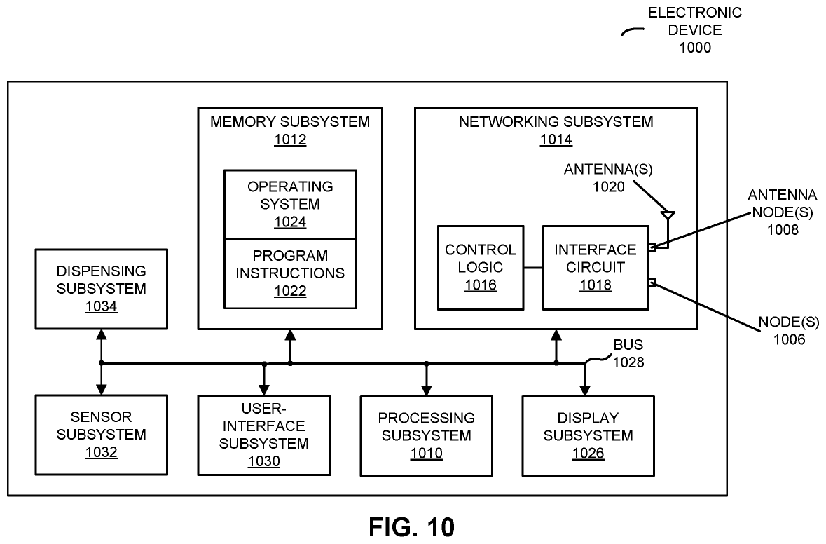

We now describe embodiments of an electronic device, which may perform at least some of the operations in the defense techniques. FIG. 10 presents a block diagram illustrating an example of an electronic device 800, e.g., portable electronic device 100 (FIG. 1) and/or computer system 216 (FIG. 2) in accordance with some embodiments. For example, electronic device 1000 may include: processing subsystem 1010, memory subsystem 1012, networking subsystem 1014 and optional dispensing subsystem 1034. Processing subsystem 1010 includes one or more devices configured to perform computational operations. For example, processing subsystem 1010 can include one or more microprocessors, ASICs, microcontrollers, programmable-logic devices, GPUs and/or one or more DSPs. Note that a given component in processing subsystem 1010 are sometimes referred to as a ‘computation device’.

Memory subsystem 1012 includes one or more devices for storing data and/or instructions for processing subsystem 1010 and networking subsystem 1014. For example, memory subsystem 1012 can include dynamic random access memory (DRAM), static random access memory (SRAM), and/or other types of memory. In some embodiments, instructions for processing subsystem 1010 in memory subsystem 1012 include: program instructions or sets of instructions (such as program instructions 1022 or operating system 1024), which may be executed by processing subsystem 1010. Note that the one or more computer programs or program instructions may constitute a computer-program mechanism. Moreover, instructions in the various program instructions in memory subsystem 1012 may be implemented in: a high-level procedural language, an object-oriented programming language, and/or in an assembly or machine language. Furthermore, the programming language may be compiled or interpreted, e.g., configurable or configured (which may be used interchangeably in this discussion), to be executed by processing subsystem 1010.

In addition, memory subsystem 1012 can include mechanisms for controlling access to the memory. In some embodiments, memory subsystem 1012 includes a memory hierarchy that comprises one or more caches coupled to a memory in electronic device 1000. In some of these embodiments, one or more of the caches is located in processing subsystem

In some embodiments, memory subsystem 1012 is coupled to one or more high-capacity mass-storage devices (not shown). For example, memory subsystem 1012 can be coupled to a magnetic or optical drive, a solid-state drive, or another type of mass-storage device. In these embodiments, memory subsystem 1012 can be used by electronic device 1000 as fast-access storage for often-used data, while the mass-storage device is used to store less frequently used data.

Networking subsystem 1014 includes one or more devices configured to couple to and communicate on a wired and/or wireless network (i.e., to perform network operations), including: control logic 1016, an interface circuit 1018 and one or more antennas 1020 (or antenna elements). (While FIG. 10 includes one or more antennas 1020, in some embodiments electronic device 1000 includes one or more nodes, such as antenna nodes 1008, e.g., a metal pad or a connector, which can be coupled to the one or more antennas 1020, or nodes 1006, which can be coupled to a wired or optical connection or link. Thus, electronic device 1000 may or may not include the one or more antennas 1020. Note that the one or more nodes 1006 and/or antenna nodes 1008 may constitute input(s) to and/or output(s) from electronic device 1000.) For example, networking subsystem 1014 can include a Bluetooth™ networking system, a cellular networking system (e.g., a 3G/4G/5G network such as UMTS, LTE, etc.), a USB networking system, a networking system based on the standards described in IEEE 802.11 (e.g., a Wi-Fi® networking system), an Ethernet networking system, and/or another networking system.

Networking subsystem 1014 includes processors, controllers, radios/antennas, sockets/plugs, and/or other devices used for coupling to, communicating on, and handling data and events for each supported networking system. Note that mechanisms used for coupling to, communicating on, and handling data and events on the network for each network system are sometimes collectively referred to as a ‘network interface’ for the network system. Moreover, in some embodiments a ‘network’ or a ‘connection’ between electronic devices does not yet exist. Therefore, electronic device 1000 may use the mechanisms in networking subsystem 1014 for performing simple wireless communication between electronic devices, e.g., transmitting advertising or beacon frames and/or scanning for advertising frames transmitted by other electronic devices.

Within electronic device 1000, processing subsystem 1010, memory subsystem 1012, and networking subsystem 1014 are coupled together using bus 1028. Bus 1028 may include an electrical, optical, and/or electro-optical connection that the subsystems can use to communicate commands and data among one another. Although only one bus 1028 is shown for clarity, different embodiments can include a different number or configuration of electrical, optical, and/or electro-optical connections among the subsystems.

In some embodiments, electronic device 1000 includes a display subsystem 1026 for displaying information on a display, which may include a display driver and the display, such as a liquid-crystal display, a multi-touch touchscreen, etc. Moreover, electronic device 1000 may include a user-interface subsystem 1030, such as: a trigger, a button, a mouse, a keyboard, a trackpad, a stylus, a voice-recognition interface, and/or another human-machine interface. Furthermore, electronic device 1000 may include a sensor subsystem 1032, which may include one or more types of sensors.

Additionally, dispensing subsystem 1034 may include: a reservoir with the liquid incapacitating chemical agent, a pump or a component that transfers the liquid incapacitating chemical agent from the reservoir to a nozzle, etc.

Electronic device 1000 can be (or can be included in) any electronic device with at least one network interface. For example, electronic device 1000 can be (or can be included in): a desktop computer, a laptop computer, a subnotebook/netbook, a server, a supercomputer, a cloud-based computer, a tablet computer, a smartphone, a smartwatch, a cellular telephone, a consumer-electronic device, a portable computing device, communication equipment, a handheld portable electronic device, a backpack, a drone, a robot and/or another electronic device.

Although specific components are used to describe electronic device 1000, in alternative embodiments, different components and/or subsystems may be present in electronic device 1000. For example, electronic device 1000 may include one or more additional processing subsystems, memory subsystems, networking subsystems, and/or display subsystems. Additionally, one or more of the subsystems may not be present in electronic device 1000. Moreover, in some embodiments, electronic device 1000 may include one or more additional subsystems that are not shown in FIG. 10. Also, although separate subsystems are shown in FIG. 10, in some embodiments some or all of a given subsystem or component can be integrated into one or more of the other subsystems or component(s) in electronic device 1000. For example, in some embodiments program instructions 1022 are included in operating system 1024 and/or control logic 1016 is included in interface circuit 1018.

Moreover, the circuits and components in electronic device 1000 may be implemented using any combination of analog and/or digital circuitry, including: bipolar, PMOS and/or NMOS gates or transistors. Furthermore, signals in these embodiments may include digital signals that have approximately discrete values and/or analog signals that have continuous values. Additionally, components and circuits may be single-ended or differential, and power supplies may be unipolar or bipolar.

An integrated circuit may implement some or all of the functionality of networking subsystem 1014 and/or electronic device 1000. The integrated circuit may include hardware and/or software mechanisms that are used for transmitting signals from electronic device 1000 and receiving signals at electronic device 1000 from other electronic devices. Aside from the mechanisms herein described, radios are generally known in the art and hence are not described in detail. In general, networking subsystem 1014 and/or the integrated circuit may include one or more radios.

In some embodiments, an output of a process for designing the integrated circuit, or a portion of the integrated circuit, which includes one or more of the circuits described herein may be a computer-readable medium such as, for example, a magnetic tape or an optical or magnetic disk or solid state disk. The computer-readable medium may be encoded with data structures or other information describing circuitry that may be physically instantiated as the integrated circuit or the portion of the integrated circuit. Although various formats may be used for such encoding, these data structures are commonly written in: Caltech Intermediate Format (CIF), Calma GDS II Stream Format (GDSII), Electronic Design Interchange Format (EDIF), OpenAccess (OA), or Open Artwork System Interchange Standard (OASIS). Those of skill in the art of integrated circuit design can develop such data structures from schematics of the type detailed above and the corresponding descriptions and encode the data structures on the computer-readable medium. Those of skill in the art of integrated circuit fabrication can use such encoded data to fabricate integrated circuits that include one or more of the circuits described herein.

While some of the operations in the preceding embodiments were implemented in hardware or software, in general the operations in the preceding embodiments can be implemented in a wide variety of configurations and architectures. Therefore, some or all of the operations in the preceding embodiments may be performed in hardware, in software or both. For example, at least some of the operations in the defense techniques may be implemented using program instructions 1022, operating system 1024 (such as a driver for interface circuit 1018) or in firmware in interface circuit 1018. Thus, the defense techniques may be implemented at runtime of program instructions 1022. Alternatively or additionally, at least some of the operations in the defense techniques may be implemented in a physical layer, such as hardware in interface circuit 1018.

In the preceding description, we refer to ‘some embodiments’. Note that ‘some embodiments’ describes a subset of all of the possible embodiments, but does not always specify the same subset of embodiments. Moreover, note that the numerical values provided are intended as illustrations of the defense techniques. In other embodiments, the numerical values can be modified or changed.

As used in the description and claims, the singular form ‘a’, ‘an’ and ‘the’ include both singular and plural references unless the context clearly dictates otherwise. For example, the term ‘acid’ may include, and is contemplated to include, a plurality of acids. At times, the claims and disclosure may include terms such as ‘a plurality,’ ‘one or more,’ or ‘at least one;’ however, the absence of such terms is not intended to mean, and should not be interpreted to mean, that a plurality is not conceived.

The term ‘about’ or ‘approximately,’ when used before a numerical designation or range (e.g., to define a length or pressure) may indicate, unless indicated otherwise, approximation which may vary by (+) or (−) 5%, 1% or 0.1%. All numerical ranges provided herein are inclusive of the stated start and end numbers. The term ‘substantially’ indicates mostly (i.e., greater than 50%) or essentially all of a device, substance, or composition.

As used herein, the term ‘comprising’ or ‘comprises’ is intended to mean that the devices, systems, and methods include the recited elements, and may additionally include any other elements. ‘Consisting essentially of’ shall mean that the devices, systems, and methods include the recited elements and exclude other elements of essential significance to the combination for the stated purpose. Thus, a system or method consisting essentially of the elements as defined herein would not exclude other materials, features, or steps that do not materially affect the basic and novel characteristic(s) of the claimed disclosure. ‘Consisting of’ shall mean that the devices, systems, and methods include the recited elements and exclude anything more than a trivial or inconsequential element or step. Embodiments defined by each of these transitional terms are within the scope of this disclosure.

The foregoing description is intended to enable any person skilled in the art to make and use the disclosure, and is provided in the context of a particular application and its requirements. Moreover, the foregoing descriptions of embodiments of the present disclosure have been presented for purposes of illustration and description only. They are not intended to be exhaustive or to limit the present disclosure to the forms disclosed. Accordingly, many modifications and variations will be apparent to practitioners skilled in the art, and the general principles defined herein may be applied to other embodiments and applications without departing from the spirit and scope of the present disclosure. Additionally, the discussion of the preceding embodiments is not intended to limit the present disclosure. Thus, the present disclosure is not intended to be limited to the embodiments shown, but is to be accorded the widest scope consistent with the principles and features disclosed herein.

1. A portable electronic device, comprising:
a reservoir configured to store a liquid incapacitating chemical agent;
a pump mechanically coupled to the reservoir;
a nozzle mechanically coupled to the pump; and
a control circuit electrically coupled to the pump, wherein the portable electronic device is configured to:
receive or provide a trigger signal;
provide, from the control circuit, a control signal to the pump based at least in part on the trigger signal;
transfer, using the pump, the liquid incapacitating chemical agent from the reservoir to the nozzle based at least in part on the control signal; and
discharge, from the nozzle, the liquid incapacitating chemical agent in a stream, wherein the stream is external to the portable electronic device.

2. The portable electronic device of claim 1, wherein the portable electronic device comprises a trigger; and
wherein, when the trigger is activated, the portable electronic device is configured to provide the trigger signal to the control circuit.

3. The portable electronic device of claim 2, wherein the trigger comprises a mechanical trigger or an electronic trigger.

4. The portable electronic device of claim 1, wherein the portable electronic device comprises one or more sensors configured to perform measurements associated with an external environment of the portable electronic device; and
wherein, when the portable electronic device receives an activation signal or an activation instruction, the portable electronic device is configured to:
perform the measurements;
analyze the measurements to identify a lifeform in the external environment in proximity to the portable electronic device; and
selectively provides the trigger signal to deploy the liquid incapacitating chemical agent based at least in part on the identified lifeform.

5. The portable electronic device of claim 4, wherein the portable electronic device comprises an interface circuit configured to communicate with a second electronic device using wireless communication; and
wherein the analysis comprises:
providing the measurements addressed to the second electronic device; and
receiving information that specifies the identified lifeform.

6. The portable electronic device of claim 4, wherein the one or more sensors comprises: an image sensor, a radar sensor, a lidar sensor, an acoustic sensor, an ultrasonic sensor, or a motion sensor.

7. The portable electronic device of claim 4, wherein the analysis comprises image analysis of one or more images using a pretrained predictive model.

8. The portable electronic device of claim 4, wherein the identifying comprises determining a type of lifeform or classification of the lifeform.

9. The portable electronic device of claim 4, wherein, when the lifeform is an individual, the identifying comprises estimating an emotional state of the individual or estimating an intent of the individual.

10. The portable electronic device of claim 1, wherein the portable electronic device comprises an interface circuit configured to communicate with a second electronic device using wireless communication; and
wherein the portable electronic device is configured to receive the trigger signal associated with the second electronic device.

11. The portable electronic device of claim 1, wherein the portable electronic device comprises: a handheld electronic device, a backpack, a cart, an airborne drone, or a terrestrial drone or robot.

12. The portable electronic device of claim 1, wherein the portable electronic device comprises a power source or a connector configured to electrically couple to an external power source.

13. The portable electronic device of claim 1, wherein the portable electronic device comprises a secure memory or a write once read many (WORM) memory; and
wherein the portable electronic device is configured to selectively increment a value stored in the secure memory or the WORM memory each instance when the liquid incapacitating chemical agent is deployed.

14. (canceled)

15. The portable electronic device of claim 1, wherein the liquid incapacitating chemical agent is water soluble.

16. The portable electronic device of claim 1, wherein the liquid incapacitating chemical agent comprises:
propionic acid;
ammonia; and
water, wherein a content of water in the liquid incapacitating chemical agent is at least approximately 60% by weight, and
wherein a content of propionic acid in the liquid incapacitating chemical agent is at least approximately 17.5% by weight.

17. The portable electronic device of claim 16, wherein a pH of the liquid incapacitating chemical agent may range from approximately 5.60 to 5.80.

18. The portable electronic device of claim 1, wherein the liquid incapacitating chemical agent comprises a solution of:
an organic acid having a pKa of 6 or less; and
water, wherein the solution has a pH between:
about 4.5 and about 6.5;
about 5 and about 6; or
about 5.5 to about 5.9.

19. A non-transitory computer-readable storage medium for use in conjunction with a portable electronic device, the computer-readable storage medium configured to store program instructions that, when executed by the portable electronic device, causes the portable electronic device to perform one or more operations comprising:
receiving or providing a trigger signal;
providing a control signal to a pump in the portable electronic device based at least in part on the trigger signal;
transferring, using the pump, a liquid incapacitating chemical agent from a reservoir in the portable electronic device to a nozzle in the portable electronic device based at least in part on the control signal; and
discharging, from the nozzle, the liquid incapacitating chemical agent in a stream, wherein the stream is external to the portable electronic device.

20. A method for selectively deploying a liquid incapacitating chemical agent, comprising:
by a portable electronic device:
receiving or providing a trigger signal;
providing a control signal to a pump in the portable electronic device based at least in part on the trigger signal;
transferring, using the pump, the liquid incapacitating chemical agent from a reservoir in the portable electronic device to a nozzle in the portable electronic device based at least in part on the control signal; and
discharging, from the nozzle, the liquid incapacitating chemical agent in a stream, wherein the stream is external to the portable electronic device.

21. The method of claim 20, wherein the liquid incapacitating chemical agent is water soluble.
